(19) United States
(12) Patent Application Publication
(10) Pub. No.: US 2009/0215460 A1
(43) Pub. Date: Aug. 27, 2009

(54) Base Station Apparatus, User Equipment, Method Used In Mobile Communications System Performing Handover Between Bandwidths

(76) Inventor: Hajime HASEGAWA, Kawasaki (JP)

Correspondence Address: HANIFY & KING PROFESSIONAL CORPORATION, 1055 Thomas Jefferson Street, NW, Suite 400, WASHINGTON, DC, 20007, US

(21) Appl. No.: 12/436,317

(22) Filed: May 6, 2009

Related U.S. Application Data
(63) Continuation of application No. PCT/JP2006/322281, filed on Nov. 8, 2006.

(51) Int. Cl. H04W 36/00

(52) U.S. Cl. 455/437

(57) ABSTRACT

A base station apparatus used in a mobile communication system performing communications using all or a part of a system bandwidth and includes a first receiving part to receive a request signal requesting handover between bandwidths from a user equipment, a first transmission part to transmit an instruction signal to one or more peripheral base stations of a handover transfer destination candidate according to the request signal, a second receiving part to receive a response signal responsive to the instruction signal from one or more peripheral base stations, a second transmission part to transmit an individual control signal, including at least frequency information of a channel measurement signal of the handover transfer destination candidate, to the user equipment according to the response signal. The channel measurement signal is transmitted from the one or more peripheral base stations in a frequency of the frequency information according to the instruction signal.

### CROSS-REFERENCE TO RELATED APPLICATIONS

This application is a U.S. continuation application filed under 35 USC 111(a) claiming benefit under 35 USC 120 and 365(c) of PCT application JP 2006/322281, filed Nov. 8, 2006. The foregoing application is hereby incorporated herein by reference.

### FIELD

The embodiments discussed herein are related to the technology field of mobile communications; for example, to a base station apparatus, user equipment, and a method used in a mobile communications system performing handover between bandwidths.

### BACKGROUND

In this type of technical field, research and development regarding next-generation mobile communication systems are being rapidly conducted. Among currently anticipated communications system, the use of an OFDM (Orthogonal Frequency Division Multiplexing) method for a downlink is highly anticipated from the aspect of, for example, increasing speed/capacity and strengthening multipath resistance. Further, the use of a SC-FDMA (Single-Carrier Frequency Division Multiple Access) method for an uplink is highly anticipated from the aspect of, for example, broadening coverage while controlling PAPR (Peak-to-Average Power Ratio).

In the above-described next-generation mobile communications systems, the wireless resources are assigned in both uplinks and downlinks in the form of shared channels among users according to the communication statuses of each user. The process of determining what to allocate is referred to as scheduling. In order to appropriately perform scheduling of the uplink, each user equipment transmits a pilot channel to a base station, so that the base station determines the channel status of the uplink according to its reception quality. Further, in order to perform scheduling of the downlink, a base station transmits a pilot channel to user equipment, the user equipment reports information indicating the channel status (CQI: Channel Quality Indicator) based on the reception quality of the pilot channel. The base station performs scheduling of the downlink by determining the channel status of the downlink of a mobile station based on the CQI reported from each user equipment.

FIG. 1 illustrates a schematic diagram of this kind of mobile communications system. This system includes an access gateway aGW connected to an upper layer apparatus, base stations eNB connected to the access gateway aGW, and user equipment UE performing wireless communications with the base stations eNB. S1 represents an interface between the access gateway aGW and the base stations eNB. X2 represents an interface between the base stations eNB. The user equipment UE can switch cells while continuing communication by performing handover (HO). Unlike before, with this mobile communications system, plural choices of wide and narrow communication bandwidths are prepared. Communications are performed according to a selected one of any of the bandwidths depending on the communication capability or available resource status of both the user equipment UE and the base stations eNB.

FIG. 2 is a diagram schematically illustrating where three communication bandwidths are prepared for a system. In the exemplarily illustrated system, communications are performed with communication frequency bandwidths of 20 MHz, 10 MHz, or 5 MHz. In the drawing, “CCH” represents a bandwidth occupied by a common control signal. The CCH contains general information related to all user equipment existing in a cell. A channel for individual control signals is used for control information dedicated for each user equipment (not illustrated in FIG. 2).

In case 1 illustrated in FIG. 3 where the transmission bandwidth of cell A is 20 MHz and the reception bandwidth of the user equipment existing in the cell A is 10 MHz, the user equipment UE performs communications by using the 10 MHz bandwidth indicated as Bw1. Because not only the Bw1 of 10 MHz but also Bw2 of 10 MHz is supported in cell A, the user equipment UE may be able to perform communication with better quality by changing the bandwidth from Bw1 to Bw2 depending on, for example, communication status. In order to determine such possibility, the user equipment, which is communicating with Bw1, is required to receive a channel measurement signal from the common control signal CCH transmitted in the other bandwidth Bw2 and determine whether to change bandwidth (handover between bandwidths) depending on whether its reception quality is good or bad.

In the illustrated example, because the common control signal CCH is transmitted in a bandwidth including the border between Bw1 and Bw2, the user equipment UE communicating in Bw1 is able to obtain frequency information of the channel measurement signal in Bw2 from the CCH and perform measurement of a desired channel. This type of mobile communications system is disclosed in, for example, Non-patent documents 1 and 2.

In case 2 illustrated in FIG. 3 where the transmission bandwidth of cells B and C is 10 MHz and the reception bandwidth of the user equipment UE existing in cell B is also 10 MHz, the user equipment UE performs communications by using the MHz bandwidth indicated as Bw1. The cell C uses the bandwidth of Bw2. The same as case 1, the user equipment UE may be able to perform communication with better quality by changing the bandwidth from Bw1 to Bw2 depending on, for example, communication status. Likewise, in order to determine such possibility, the user equipment, which is communicating with Bw1, is required to receive a channel measurement signal from the common control signal CCH transmitted in the other bandwidth Bw2 and determine whether to change bandwidth (handover between bandwidths) depending on whether its reception quality is good or bad. However, unlike case 1, the user equipment UE in case 2 cannot obtain frequency information of the channel measurement signal in Bw2 from the CCH in Bw1 during communications. If the frequency information of the channel measurement signal in Bw2 is unknown, the user equipment UE may not be able to promptly perform handover between bandwidths.

In this case, if the frequency information of the channel measurement signals of all peripheral cells are reported by broadcast signals (BCH) in the current cell, the user equipment UE can always receive necessary information, promptly tune to the frequency, and perform channel measurement of its transfer destination cell. However, wireless resources for broadcast signals are comparatively few. Thus, it may be difficult to cover the information of channel measurement signals of all peripheral cells with the broadcast signals. Since the number of peripheral cells tends to increase as cell radius is shortened, there is a possibility of graver problems.

The cell of the handover destination does not always belong in the same system. In future mobile communications systems, it is possible that different systems will coexist in the same area. It is possible that services will be provided by different operators and different vendors in a neighboring cell. Therefore, it may be difficult to uniformly determine information of the channel measurement signal of each cell beforehand. For example, in one system, common control signals CCH may be transmitted at the vicinity of the center of a bandwidth of the system whereas CCH may be transmitted at one end of the bandwidth of the other system.

Non-patent document 1: 3GPP TR25.13 V7.3.0(2006-03)
Non-patent document 2: 3GPP TR25.912 V7.0.0 (2006-06)

### SUMMARY

According to an aspect of the invention, there is provided a base station apparatus used in a mobile communication system performing communications using all or a part of a system bandwidth, the base station apparatus including a first receiving part to receive a request signal requesting handover between bandwidths from a user equipment, a first transmission part to transmit an instruction signal to one or more peripheral base stations of a handover transfer destination candidate according to the request signal, a second receiving part to receive a response signal responsive to the instruction signal from one or more peripheral base stations, a second transmission part to transmit an individual control signal, including at least frequency information of a channel measurement signal of the handover transfer destination candidate, to the user equipment according to the response signal, wherein the channel measurement signal is transmitted from the one or more peripheral base stations in a frequency of the frequency information according to the instruction signal.

The object and advantages of the invention will be realized and attained by means of the elements and combinations particularly pointed out in the claims.

It is to be understood that both the foregoing generation description and the followed detailed description are exemplary and explanatory and are not restrictive of the invention, as claimed.

### BRIEF DESCRIPTION OF DRAWINGS

FIG. 1 is a schematic diagram illustrating a mobile communication system;

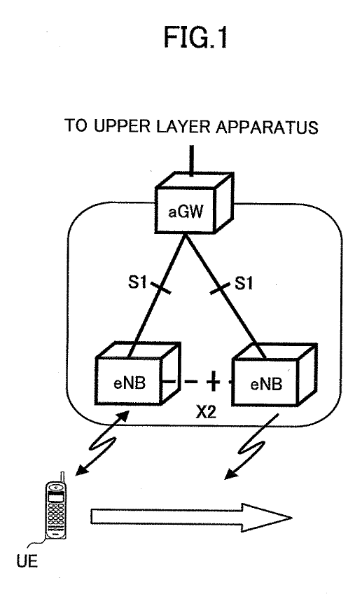

FIG. 2 is a drawing illustrating system bandwidths and an example of mapping common control signals;

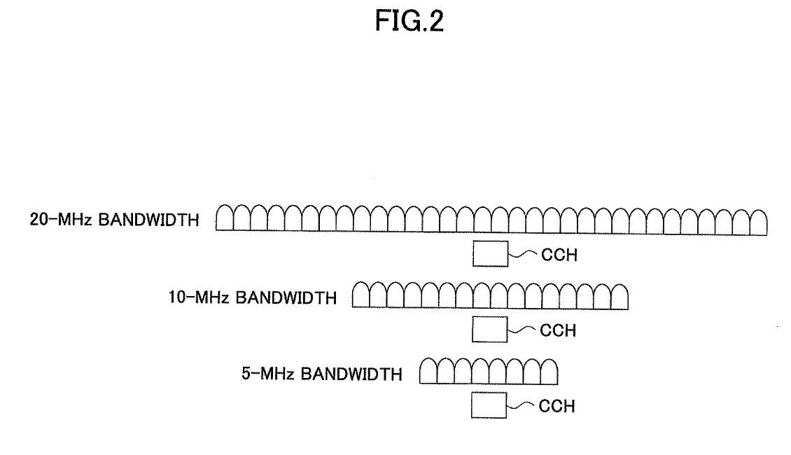

FIG. 3 is an explanatory diagram for explaining problems of handover between bandwidths;

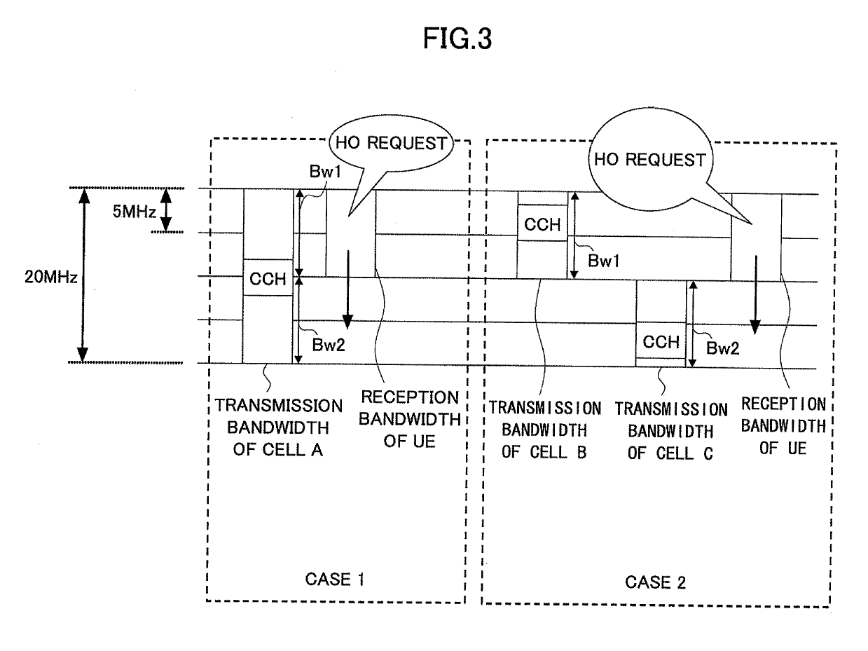

FIG. 4 is a block diagram of user equipment according to an embodiment of the present invention;

FIG. 5 is a block diagram of a base station apparatus according to an embodiment of the present invention;

FIG. 6 is a flowchart (part 1) of operations according to a first embodiment of the present invention;

FIG. 7 is a flowchart (part 2) of operations according to a first embodiment of the present invention;

FIG. 8 is a flowchart of operations according to a second embodiment of the present invention;

FIG. 9 is a diagram schematically illustrating an example of mapping CCH;

FIG. 10 is a diagram schematically illustrating another example of mapping CCH; and

FIG. 11 is a flowchart of operations according to a fourth embodiment of the present invention.

### DESCRIPTION OF EMBODIMENTS

According to an embodiment of the present invention, when there is a handover request from user equipment UE, communication is performed between a base station of a transfer origin of the hand-over and a base station of a candidate transfer destination of the handover, and information of the channel measurement signal of the candidate transfer destination is notified to the user equipment from the transfer origin. Each candidate transfer destination wirelessly transmits a channel measurement signal according to an instruction signal from the transfer origin. By receiving the channel measurement signals, the user equipment can perform channel measurement. Therefore, even if the base station of the transfer origin does not report the information of the channel measurement signals of all candidate transfer destinations, the user equipment can simply yet appropriately be notified of information required for channel measurement of another bandwidth.

Frequency information of channel measurement signals transmitted from one or more peripheral base stations may be known or not known before receiving a request signal. In a case where it is known, it is advantageous in that frequency information does not need to be included in a response signal. In a case where it is not known, it is preferable from the aspect that appropriate frequency information can be accurately notified in an area where systems of various operators coexist.

Individual control signals may include not only frequency information of channel measurement signals but also transmission timing information.

In a case where a system has plural frequency blocks included in its bandwidth and plural resource blocks included in each frequency block, a base station apparatus thereof can allocate one or more frequency resource blocks in a frequency block assigned to the user equipment. In such a mobile communication system, it is particularly important to allow handover between bandwidths to be performed easily from the aspect of, for example, efficient use of wireless resources.

Information indicating the current cell of the user equipment can be included in the signal requesting handover. This is preferable from the aspect of promptly determining the corresponding relationship between the user equipment, the base station of the handover origin, and peripheral base stations.

Wireless resources of channel measurement signals may be searched for in at least one peripheral base station, and information indicating the wireless resource according to the search result may be included in the individual control signal. This is preferable from the aspect of increasing the chances of enabling a more suitable wireless resource to be used for channel measurement.

It may be indicated by the transmission timing information that the channel measurement signals, as a rule, are wirelessly transmitted within intermittent periods. Further, in a case where an instruction signal is transmitted, the channel measurement signals, as an exception, may be wirelessly transmitted even though not within the intermittent periods. This is preferable from the aspect of promptly completing handover.

### Embodiment 1

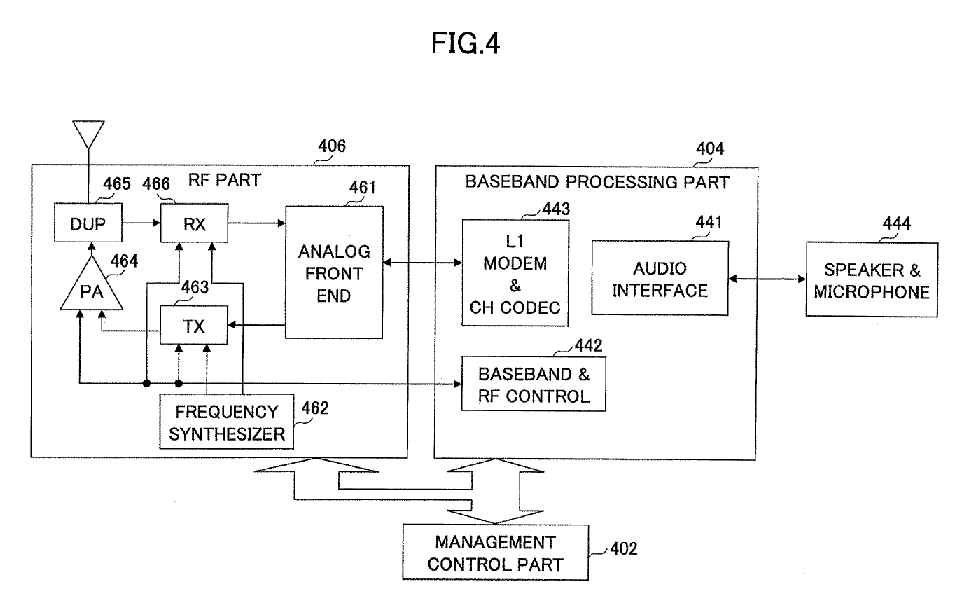

FIG. 4 is a block diagram illustrating user equipment (may also be referred as, for example, UE, MS, MH) according to an embodiment of the present invention. Although the user equipment illustrated in FIG. 4 is an example of a typical mobile terminal, it maybe a transportable mobile station/fixed terminal. The user equipment includes a management control part 402, a baseband processing part 404, and a RF part 406.

The baseband processing part 404 includes an audio interface part 441, a baseband & RF control part 442, and a L1 modem & channel codec part 443. The RF part 406 includes an analog front end part 461, a frequency synthesizer 462, a transmission part (TX) 463, an electric power amplifying part (PA) 464, a duplexer (DUP) 465 connected to an antenna, and a reception part (RX) 466.

The management control part 402 controls operations of the baseband processing part 404 and the RF part 406. More specifically, management of wireless channels, management of quality, management of mobility, etc., are performed. Channel measurements which lead to the below-described handover between bandwidths and generation of request signals of handover, etc., are also performed.

The audio interface part 441 of the baseband process part 404 is connected to a speaker & microphone 444 and is an interface for exchanging audio signals.

The baseband & RF control part 442 appropriately adjusts communication bandwidths.

The L1 modem & channel codec part 443 performs processes (e.g., encoding (error correction encoding, data modulation) on information to be transmitted and generates transmission symbols of baseband. The L1 modem & channel codec part 443 performs processes (e.g., Fourier transform, data de-modulation, channel decoding (error correction)) on received baseband signals and restores the transmitted information.

The analog front end part 461 of the RF part 406 performs processes such as digital to analog conversion and bandwidth control on the baseband signals to be transmitted. Further, the analog front end part 461 performs processes such as bandwidth control and analog to digital conversion on received analog signals and changes them into baseband signals.

The frequency synthesizers 462 supplies predetermined frequencies so that a transmitter is tuned to a transmission frequency and a receiver is tuned to a reception frequency.

The transmitting part (TX) 463 performs, for example, orthogonal modulation on transmission signals and frequency conversion to wireless frequency signals.

The power amplifying part (PA) 464 amplifies the power of transmission signals to an antenna transmission level.

The duplexer (DUP) 465 appropriately separates transmission signals and reception signals.

The reception part (RX) 466 performs processes such as the orthogonal demodulation of reception signals and conversion of analog signals to baseband signals.

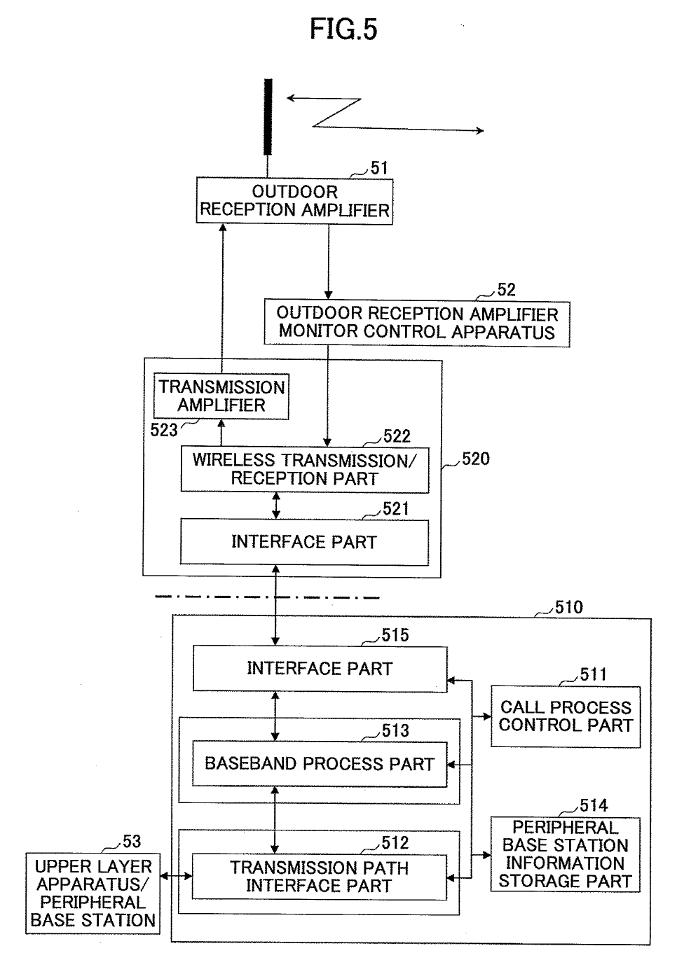

FIG. 5 is a block diagram illustrating a base station (may also be referred as, for example, NodeB, eNB, BS, BTS) according to an embodiment of the present invention. The base station includes a radio equipment control part 510 and a radio equipment part 520.

The radio equipment control part 510 includes a call process control part 511, a transmission path interface part 512, a baseband process part 513, a peripheral base station information storage part 514, and an interface part 515. The radio equipment part 520 includes an interface part 521, a wireless transmission/reception part 522, and a transmission amplifier 523.

The call process control part 511 performs control of call processes. More specifically, management of wireless channels, management of physical lines, management of quality control, etc., are performed. Scheduling for planning the allocation of wireless resources in the uplinks and downlinks is also performed here.

The transmission path interface part 512 is connected to an upper layer apparatus or other base stations 53 by cable (it may be optical or electrical) and is an interface between, for example, the upper layer apparatus 53 and the base station.

The baseband process part 513 performs processes such as channel encoding (error correction encoding) of a wireless transmission signal, data modulation, and inverse Fourier transform. The baseband process part 513 performs processes such as channel decoding (error correction) of a wireless reception signal and data demodulation.

The peripheral base station information storage part 514 stores a corresponding relationship between the apparatus itself and peripheral base stations. The peripheral base station information storage part may store information of the channel measurement signals currently used in the peripheral base stations (e.g., frequency, transmission timing) according to necessity.

The interface part 515 is an interface between the radio equipment control part 510 and the radio equipment part 520. The interface part 515 is advantageous particularly when the radio equipment control part and the radio equipment part are significantly separated in terms of location.

The same as the interface part 515 of the radio equipment control part 510, the interface part 521 of the radio equipment part 520 is an interface between the radio equipment control part and radio equipment parts.

The wireless transmission/reception part 522 performs processes such as digital to analog conversion of transmission signals of base band, and orthogonal modulation. The wireless transmission/reception part 522 processes such as synchronous detection, orthogonal demodulation, and analog to digital conversion.

The transmission amplifier 523 amplifies the power of transmission signals to an antenna transmission level.

The outdoor reception amplifier 51 consists of low noise amplifiers.

The outdoor reception amplifier monitor control apparatus 52 monitors signals received through the outdoor reception amplifiers.

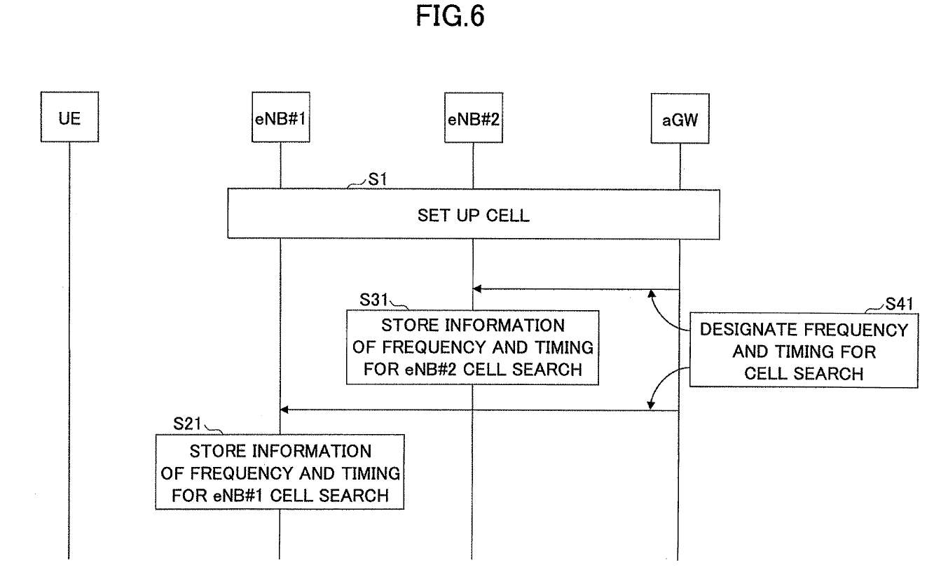

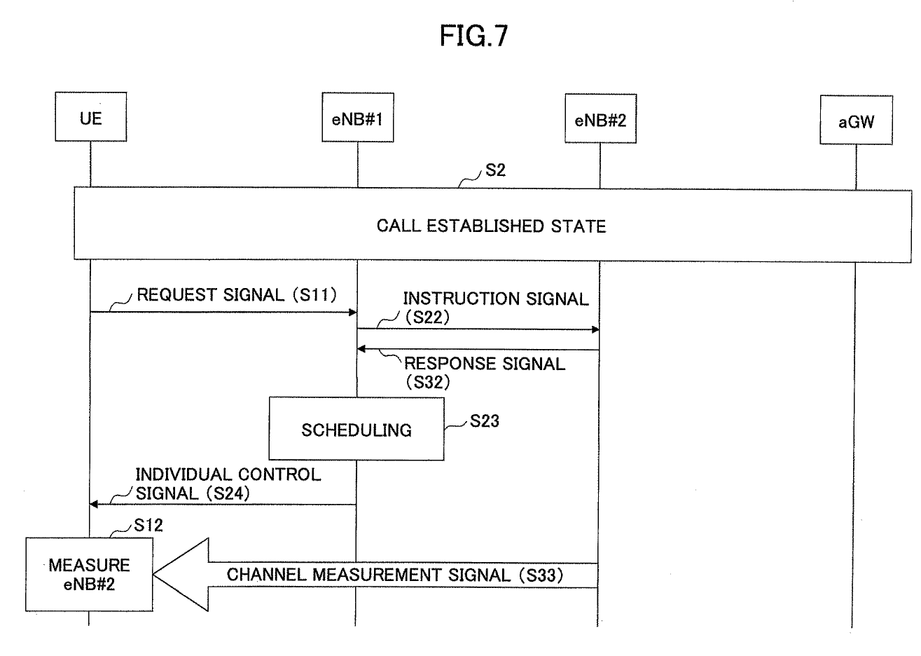

FIGS. 6 and 7 show flowcharts (part 1 and 2) of exemplary operations according to the first embodiment of the present invention. Generally, single digit step numbers represent procedures which are relatively unimportant for the present invention. The step numbers in the tens represent procedures performed by or procedures instructed by the user equipment. The step numbers in the twenties represent procedures performed by or procedures instructed by a handover origin base station eNB#1. The step numbers in their thirties represent procedures performed by or procedures instructed by a handover destination base station eNB#2. The step numbers in their forties represent procedures performed by or procedures instructed by an access gateway aGW.

In step S1 of FIG. 6, a cell setup procedure is executed, and setting of various parameters is performed so that base stations eNB#1, eNB#2 subordinate to a certain access Gateway aGW are appropriately connected. Although the example in the drawing illustrates two base stations for the sake of simplifying explanation, more than two base stations may participate. The cell setup procedure may be executed in a case where a base station is newly established or re-established, a case where a base station is reset, or a case where a used bandwidth is changed (e.g., change from 20 MHz to 10 MHz).

In step S41, the information of the channel measurement signal (frequency and timing for a cell search) is notified to each base station eNB#1 and eNB#2 from the access gateway aGW. In this embodiment, unlike the below-described second embodiment, the information of the channel measurement signals is managed in a unified manner by the access gateway aGW and is determined at the time of the cell setup.

In step S21, information (frequency and timing for a cell search) indicating how to transmit channel measurement signals is notified to the base station eNB#1, and the information is stored by the base station eNB#1.

In step S31, information (frequency and timing for a cell search) indicating how to transmit channel measurement signals is notified to the base stations eNB#2, and the information is stored by the base station eNB#2.

In step S2 of FIG. 7 illustrates a call established state where a call of a certain user equipment UE is started. Thereby, the user equipment UE can perform wireless communications by receiving allocation of wireless resources from a base station eNB#1. Although the base station eNB#2 in the periphery of the base station eNB#1 does not participate in the communication with the user equipment UE at this time, confirmation is made that they are both peripheral base stations.

The user equipment UE measures reception signal quality while performing communication in the cell of the base station eNB#1. In a case where an event such as degrading of quality occurs, a handover request signal (specifically, a measurement report message) indicating the event is generated.

In step S11, the user equipment UE transmits the handover request signal to a currently connected base station eNB#1.

In step S22, the base station eNB#1 of the handover origin transmits an instruction signal to the peripheral base station eNB#2 according to the handover request signal. The instruction signal is a signal to peripheral base stations which instructs starting of wireless communication of the channel measurement signals. The instruction signal may be transmitted to all peripheral base stations, or may be transmitted only to a limited portion of peripheral base stations in view of, for example, the location of the user equipment. It is preferable for the handover request signal to include identification information UEID which identifies the user equipment, information indicating that handover is necessary, and information indicating in what cell the user equipment currently exists (information indicating that the connected base station is eNB#1). This is because the relationship between the user equipment UE desiring handover, the handover origin base station eNB#1, and the handover destination base station eNB#2 can be promptly identified. By using this corresponding relationship, information of the channel measurement signals of each peripheral base station can be included in the below-described individual control signals. This is because, when the information indicating the eNB#1 is not included in the handover request, it becomes necessary to confirm whether the user equipment exists in its cell after the handover request signal is received, which becomes troublesome.

In step S32, a response signal responsive to the instruction signal is transmitted from the peripheral base station eNB#2 to the handover origin base station eNB#1.

In step S23, scheduling of wireless resources is performed. Generally, individual control signals are also used for notifying scheduling information indicating how to allocate wireless resources of uplinks and downlinks for transmitting user data signals. The base station eNB#1 of the transfer origin performs the scheduling of wireless resources for the user equipment by avoiding interference with the frequency and timing of the channel measurement signals of the peripheral base station eNB#2 so that the user equipment can shift to a frequency of another bandwidth and perform channel measurement. The individual control signal is generated including the scheduling information according to necessity and including information (e.g., frequency information and transmission timing information) of the channel measurement signals currently used in the cell (peripheral base station eNB#2) of the handover destination.

In step S24, the individual control signal created in such manner is wirelessly transmitted from the handover origin base station eNB#1 to the user equipment UE. The individual control signal may be referred to as measurement control. It is to be noted that the information of the channel measurement signals used by the cell (peripheral base station eNB#2) of the handover destination may or may not be included in the response signal of step S32. In the latter case where the information is not included in the response signal, the base station eNB#1 is not only required to store the information of the channel measurement signals of own station but also the information of the channel measurement signals of the peripheral base station eNB#2.

In step S12, according to the information notified by the individual control signal, the user equipment UE matches reception frequency with the channel measurement signal of the transfer destination cell and performs channel measurement. If the timing for transmission is also designated, control is performed so that the channel measurement signals are received according to the timing. Although a pilot signal may be used as a signal for channel measurement, other signals may also be used.

As illustrated in step S33, the channel measurement signal is wirelessly transmitted from the transfer destination base station eNB#2 according to a predetermined frequency and timing. As described above, the predetermined frequency and timing are decided at the time of step S41. In this case, the channel measurement signal may actually be wirelessly transmitted from the transfer destination base station eNB#2 according to the predetermined frequency and timing rather than an instruction signal from the transfer origin base station. Alternatively, even where the frequency and timing of the channel measurement signal are predetermined, the channel measurement signal may not be a wireless transmission unless there is an instruction signal from the transfer origin base station and wirelessly transmitted from the transfer destination base station eNB#2 is made according to the predetermined frequency and timing only when the transfer destination base station receives an instruction signal.

### Embodiment 2

In the first embodiment, the information of the channel measurement signals of the peripheral base station may be known beforehand in the handover origin base station eNB#1 before receiving a handover request signal. However, in a circumstance where various kinds of systems, operators, vendors, etc. exist, it is not easy to prepare all of information in advance. The second embodiment of the present invention is for resolving such problems.

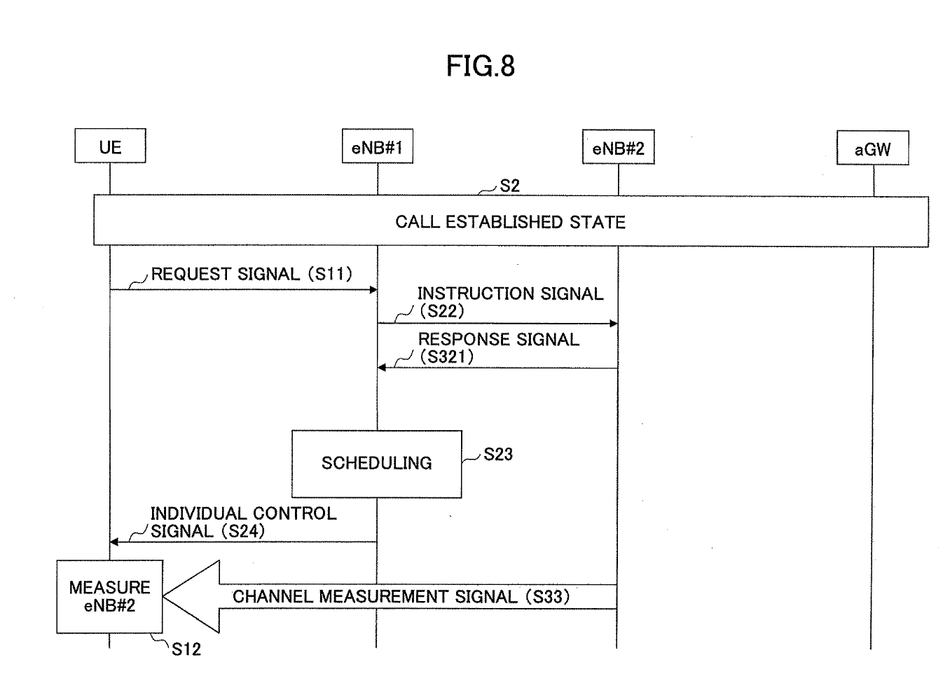

FIG. 8 illustrates a flowchart of operations according to the second embodiment of the present invention. This flowchart is basically the same as that of the flowchart illustrated in FIG. 7. In this embodiment, information of channel measurement signals is not managed in a unified manner by an upper layer apparatus of the base station (access gateway aGW) as in step S41 of FIG. 6. Therefore, the base station eNB#1 of the handover origin does not know the information of the channel measurement signal of the peripheral base station before receiving a handover request signal. This information needs to be included in the response signal responsive to the instruction signal from the transfer origin base station eNB#1 (step S321). This is different from the first embodiment where such information is not required to be included in the response signal. The transfer origin base station eNB#1 can collect the information of the channel measurement signal of peripheral base stations by receiving response signals from one or more of the peripheral base stations. Below, in the same manner as the procedures described above with FIG. 7, an individual control signal including the information is generated and scheduled (step S23) and transmitted (step S24).

### Embodiment 3

The information of the channel measurement signal included in the common control signal CCH may be identified by either one of or both of the frequency information and the transmission timing information.

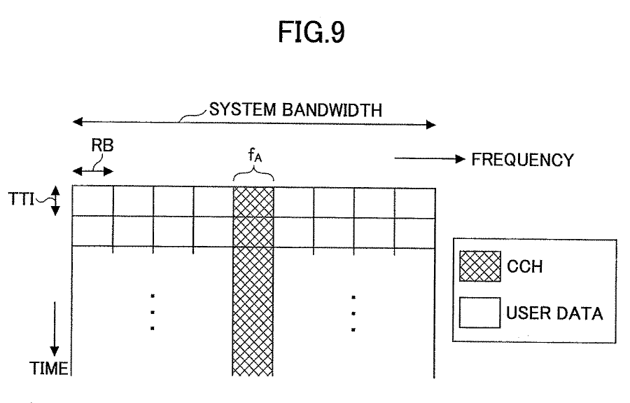

FIG. 9 schematically illustrates mapping of the common control signal CCH from a viewpoint of both time and frequency. There is illustrated an example where common control signals CCH are consecutively transmitted at a frequency f_{A} in a cell A. The system bandwidth is a bandwidth currently supported in a cell such as 20 MHz or 10 MHz. As described above, the user equipment UE performs communications using one or more resource blocks (RB) in all or a part of the frequency bands of the system bandwidth. The planning of allocating the resource blocks is performed by scheduling of the base stations. The unit of the wireless resource to be allocated with respect to the direction of the frequency axis is a single resource block (RB) and the unit of the wireless resource to be allocated with respect to the direction of the time axis is a single transmission time interval (TTI). In a case where the common control signal CCH is transmitted in a manner illustrated in FIG. 9, the information of the channel measurement signal notified to the user equipment may simply be only the frequency information (information indicating that the frequency is f_{A}).

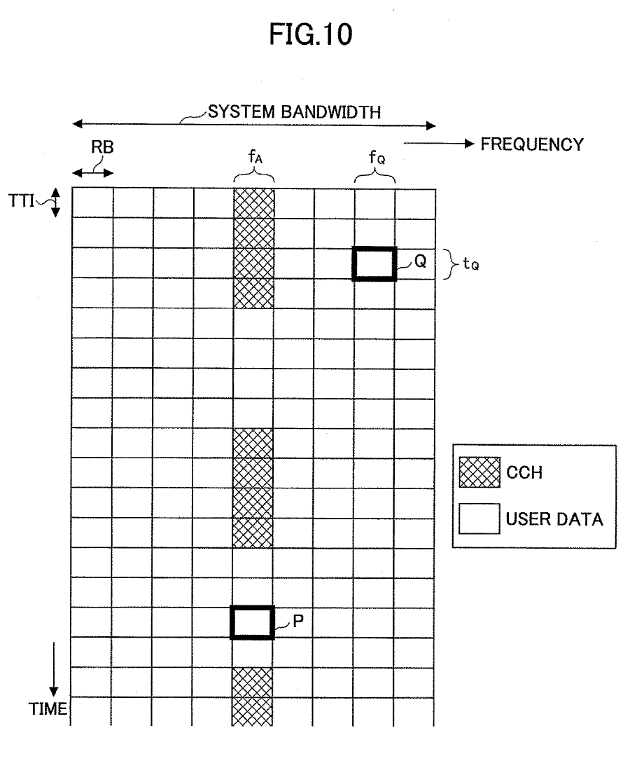

FIG. 10 illustrates another example of mapping the common control signal CCH. Although the common control signal CCH is transmitted with the same frequency f_{A} as illustrated in FIG. 9, it is different in that the common control signal CCH is not always sent consecutively and transmitted intermittently every 4 TTIs. In this case, the information of the channel measurement signal notified to the user equipment may include timing information (information indicating that transmission timing is intermittent every 4 TTIs) in addition to frequency information (information indicating that the frequency is f_{A}). However, in a case where insignificant channel measurement is allowed to be performed over the period of a maximum of 4 TTI, only frequency information may be notified to the user equipment.

In the example illustrated in FIG. 10, the timing for performing significant channel measurement is made to wait for a maximum of 4 TTIs because the common control signal CCH is transmitted intermittently every 4 TTIs. Since this delay causes delay of handover, this delay is not desirable from an aspect of promptly performing handover. From the aspect of promptly performing handover, it is advantageous to, for example, transmit channel measurement signals with the frequency f_{A} as an exception when receiving an instruction signal from the handover transfer origin base station in a case where the common control signal CCH is, as a rule, transmitted within the period of 4 TTIs. In FIG. 10, the wireless resource indicated as “P” is used for transmission of the common control signal CCH as an exception. Thus, by conducting scheduling of the allocation of the wireless resources, the problem regarding the delay of handover can be resolved.

### Embodiment 4

In the above-described embodiments, since there is a premise that the channel measurement signal is included in the common control signal CCH, it is assumed that the frequency and/or transmission timing of the channel measurement signal is fixed. However, in terms of at least the channel measurement signal, it does not need to be fixed inside a cell. In other words, the signals used for channel measurement may use any of the resources available. The fourth embodiment of the present invention describes an example where wireless resources used for channel measurement signals are not determined by transmission of response signals.

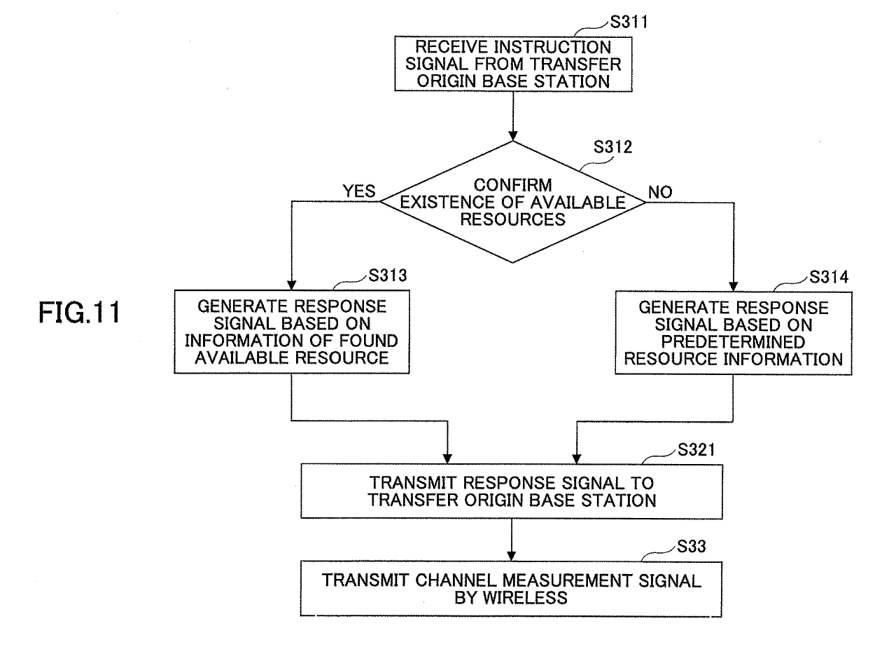

FIG. 11 illustrates a flowchart of operations according to the fourth embodiment. Step S311 of the drawing corresponds to step S22 of FIG. 8, and steps S321 and S33 are the same as those of FIG. 8. Therefore, step S312, S313, and S314 are performed between steps S22 and S321 of FIG. 8 and performed in the candidate transfer destination base station eNB#2.

In step S311, an instruction signal is received from the transfer origin base station eNB#1 upon its receiving a handover request from the user equipment.

In step S312, the existence of available resources is confirmed. For example, as illustrated in FIG. 10, when a common control signal (including channel measurement signal) is mapped, available resources (indicated as “Q”) are searched for. If an available resource is found, the flow proceeds to step S313.

In step S313, the frequency information and the transmission timing information (in the illustrated example, information where frequency is indicated as “f_{Q}” and transmission timing is indicated as “t_{Q}”) for identifying the available resource are included in the response signal of the base stations eNB#1.

On the other hand, if no available resource is found in step S312, the flow proceeds to step S314.

In step S314, the information indicating the fixed resource ensured in the channel measurement signal of the base station eNB#2 (in the illustrated example, information where frequency is indicated as “f_{A}” and information indicating that intermittent transmission of every 4 TTIs) is included in the response signal of the base station eNB#1.

In step S321, the response signal which designates an available resource or a predetermined resource is transmitted to the base station eNB#1.

In step S33, the channel measurement signal is wirelessly transmitted according to the content designated in the response signal.

The target of the search for available resources may be all of the wireless resources to be allocated or a portion thereof. In the example illustrated in FIG. 10, the search for available resources may be limited to the period 4 TTIs where no CCH is transmitted and the channel measurement signals of CCH may be used in a case of transmitting CCH. Furthermore, from an aspect of promptly completing handover, a given wireless resource may be scheduled with priority without depending on the existence of available resources.

With the above-described embodiments, user equipment can be easily notified which frequency is to be measured by the user equipment in preparation for frequency bandwidth handover.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A base station apparatus used in a mobile communication system performing communications using all or a part of a system bandwidth, the base station apparatus comprising:
a first receiving part to receive a request signal requesting handover between bandwidths from a user equipment;
a first transmission part to transmit an instruction signal to one or more peripheral base stations of a handover transfer destination candidate according to the request signal;
a second receiving part to receive a response signal responsive to the instruction signal from one or more peripheral base stations;
a second transmission part to transmit an individual control signal, including at least frequency information of a channel measurement signal of the handover transfer destination candidate, to the user equipment according to the response signal;
wherein the channel measurement signal is transmitted from the one or more peripheral base stations in a frequency of the frequency information according to the instruction signal.

2. The base station apparatus as claimed in claim 1, wherein the frequency information of the channel measurement signal transmitted from each of the one or more peripheral base stations is known before receiving the request signal.

3. The base station apparatus as claimed in claim 1, wherein the frequency information of the channel measurement signal transmitted from each of the one or more peripheral base stations is not known before receiving the request signal.

4. The base station apparatus as claimed in claim 1, wherein the individual control signal includes the frequency information and transmission timing information of the channel measurement signal.

5. The base station apparatus as claimed in claim 1, wherein a plurality of frequency blocks are included in the system bandwidth, wherein each of the frequency blocks includes a plurality of frequency resource blocks, wherein the base station apparatus allocates one or more of the frequency resource blocks in the frequency block assigned to the user equipment.

6. The base station apparatus as claimed in claim 1, wherein information indicating a current cell of the user equipment is included in the request signal.

7. The base station apparatus as claimed in claim 3, wherein a wireless resource of the channel measurement signal is searched for in at least one of the peripheral base stations, wherein information indicating the wireless resource determined according to a result of the search is included in the individual control signal.

8. The base station apparatus as claimed in claim 4, wherein the transmission timing information indicates that the channel measurement signal is wirelessly transmitted during an intermittent predetermined period.

9. A method used by a base station apparatus of a mobile communication system performing communications using all or a part of a system bandwidth, the method comprising:
receiving a request signal requesting handover between bandwidths from a user equipment;
transmitting an instruction signal to one or more peripheral base stations of a handover transfer destination candidate according to the request signal;
receiving a response signal responsive to the instruction signal from the one or more peripheral base stations;
transmitting an individual control signal, including at least frequency information of a channel measurement signal of the handover transfer destination candidate, to the user equipment according to the response signal;
wherein the channel measurement signal is transmitted from the one or more peripheral base stations in a frequency of the frequency information according to the instruction signal.

10. A base station apparatus used in a mobile communication system performing communications using all or a part of a system bandwidth, the base station apparatus comprising:
a receiving part to receive an instruction signal from a transfer origin base station of a handover caused by a request for handover between bandwidths from a user equipment;
a first transmission part to transmit a response signal according to the instruction signal so that at least frequency information of a channel measurement signal is notified to the user equipment;
a second transmission part to transmit the channel measurement signal in a frequency of the frequency information according to the instruction signal;
wherein an individual control signal including at least the frequency information of the channel measurement signal is transmitted from the transfer origin base station to the user equipment.

11. The base station apparatus as claimed in claim 10, wherein a wireless resource of the channel measurement signal is searched for in at least one of the peripheral base stations, wherein information indicating the wireless resource determined according to a result of the search is included in the response signal.

12. The base station apparatus as claimed in claim 10, wherein the response signal includes the frequency information and the transmission timing information of the channel measurement signal.

13. The base station apparatus as claimed in claim 12, wherein the transmission timing information indicates that the channel measurement signal is wirelessly transmitted during an intermittent predetermined period.

14. A method used by a base station apparatus of a mobile communication system performing communications using all or a part of a system bandwidth, the method comprising:
receiving an instruction signal from a transfer origin base station of a handover caused by a request for handover between bandwidths from a user equipment;
transmitting a response signal according to the instruction signal so that at least frequency information of a channel measurement signal is notified to the user equipment; and
transmitting the channel measurement signal in a frequency of the frequency information according to the instruction signal;
wherein an individual control signal including at least the frequency information of the channel measurement signal is transmitted from the transfer origin base station to the user equipment.

15. A user equipment used in a mobile communication system performing communications using all or a part of a system bandwidth, the user equipment comprising:
a transmission part to transmit a request signal requesting handover between bandwidths to a transfer origin base station of the handover;
a first receiving part to receive an individual control signal, including at least frequency information of a channel measurement signal of one or more handover transfer destination candidates, from the transfer origin base station; and
a second receiving part to receive the channel measurement signal in a frequency of the frequency information from one or more peripheral base stations of the handover transfer destination candidates.

16. The user equipment as claimed in claim 15, wherein the individual control signal includes the frequency information and transmission timing information of the channel measurement signal.

17. The user equipment as claimed in claim 15, wherein information indicating a current cell of the user equipment is included in the request signal.

18. The user equipment as claimed in claim 15, wherein a wireless resource of the channel measurement signal is searched for in at least one of the peripheral base stations, wherein information indicating the wireless resource determined according to a result of the search is included in the individual control signal.

19. The user equipment as claimed in claim 16, wherein the transmission timing information indicates that the channel measurement signal is wirelessly transmitted during an intermittent predetermined period.

20. A method used by a user equipment of a mobile communication system performing communications using all or a part of a system bandwidth, the method comprising:
transmitting a request signal requesting handover between bandwidths to a transfer origin base station of the handover;
receiving an individual control signal, including at least frequency information of a channel measurement signal of one or more handover transfer destination candidates, from the transfer origin base station; and
receiving the channel measurement signal in a frequency of the frequency information from one or more peripheral base stations of the handover transfer destination candidates.
